(19) United States
(12) Patent Application Publication
(10) Pub. No.: US 2017/0046650 A1
(43) Pub. Date: Feb. 16, 2017

(54) Work Management Systems and Methods

(71) Applicants: Pradip Mulji, Cedar Park, TX (US); George Bernard Smith, Cedar Park, TX (US)

(72) Inventors: Pradip Mulji, Cedar Park, TX (US); George Bernard Smith, Cedar Park, TX (US)

(21) Appl. No.: 14/824,587

(22) Filed: Aug. 12, 2015

(51) Int. Cl. G06Q 10/06; G06Q 50/12

(52) U.S. Cl. CPC G06Q 10/063116; G06Q 50/12

(57) ABSTRACT

Work management systems and method are described, specifically providing examples of hotel work management systems and methods. An apparatus may include a work management system that tracks tasks to be done. Each task may be assigned to a user, which the user may access a task list view a remote device. The work management system may be updated in real-time when a task is finished, a task is added, or a task is removed. The work management system may then update the user task list in real-time to allow a user device to see updated tasks on the remote device. Further, the system can track maintenance issues with photographic record(s).

### CROSS REFERENCE TO RELATED APPLICATIONS

The present application is a continuation of and claims priority to co-pending U.S. patent application Ser. No. 13/894,415, entitled Work Management Systems and Methods, filed on May 14, 2013, which is a non-provisional of and claims priority to Provisional Patent Application No. 61/646,894, entitled Work Management Systems and Methods, filed on May 14, 2012, the contents of which are all hereby incorporated by reference in their entireties.

### BACKGROUND

The present disclosure is generally related to work management systems and methods. Specifically, hotel work management systems and methods are provided as examples.

### BRIEF DESCRIPTION OF THE DRAWINGS

FIG. 1 is a diagram of an embodiment of a work management system;

FIG. 2 is a diagram of embodiments of work management systems and methods;

FIG. 3 is a diagram of embodiments of work management systems and methods;

FIG. 4 is a diagram of an embodiment of a GUI for a work management system;

FIG. 5 is a diagram of an embodiment of a GUI for a work management system;

FIG. 6 is a diagram of an embodiment of a GUI for a work management system;

FIG. 7 is a diagram of an embodiment of a GUI for a work management system;

FIG. 8 is a diagram of an embodiment of a GUI for a work management system;

FIG. 9 is a diagram of an embodiment of a GUI for a work management system;

FIG. 10 is a diagram of an embodiment of a GUI for a work management system; and

FIG. 11 is a diagram of an embodiment of a GUI for a work management system.

### DETAILED DESCRIPTION

In the following detailed description of the embodiments, reference is made to the accompanying drawings which form a part hereof, and in which are shown by way of illustration of example embodiments. It is to be understood that features of the various described embodiments and examples may be combined, other embodiments may be utilized, and structural changes may be made without departing from the scope of the present disclosure.

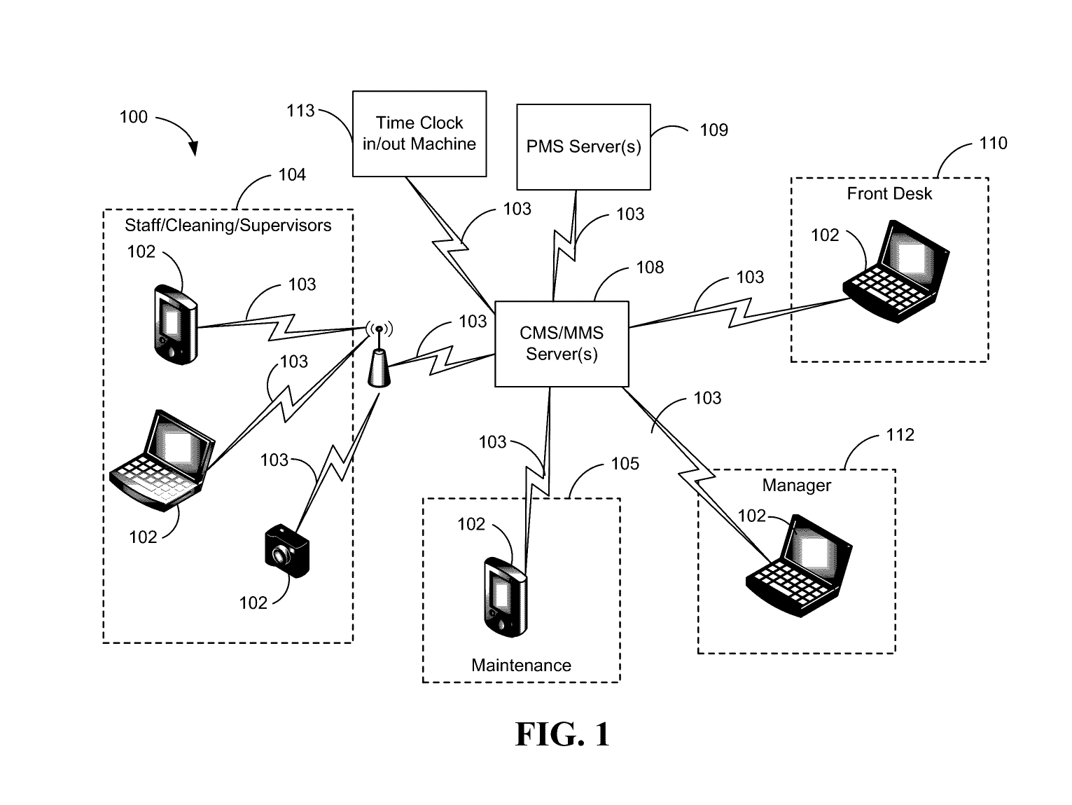

FIG. 1 depicts a diagram of an embodiment of a work management system, generally designated 100. In some examples, the work management system 100 may be used to manage tasks, such as cleaning and maintenance, for a hotel. The system 100 may include a computer server 108 and software application(s), such as the later described cleaning management system (CMS) or maintenance management system (MMS), running on the server. The software may be executed by a processor to provide a user interface or other data to a display coupled to the server 108 or to another computing device, such as a laptop computer, a tablet computer, a smart phone, or other computing device, over network(s) 103. The server 108 may receive data from another server 109, such as server that runs a hotel's property management system (PMS). The network(s) 103 may be internet, intranet, the world wide web, or another kind of network, and the network(s) 103 can be wired or wireless. The server 108 may include one or more computers, processors, and memories and may have other servers communicatively coupled thereto.

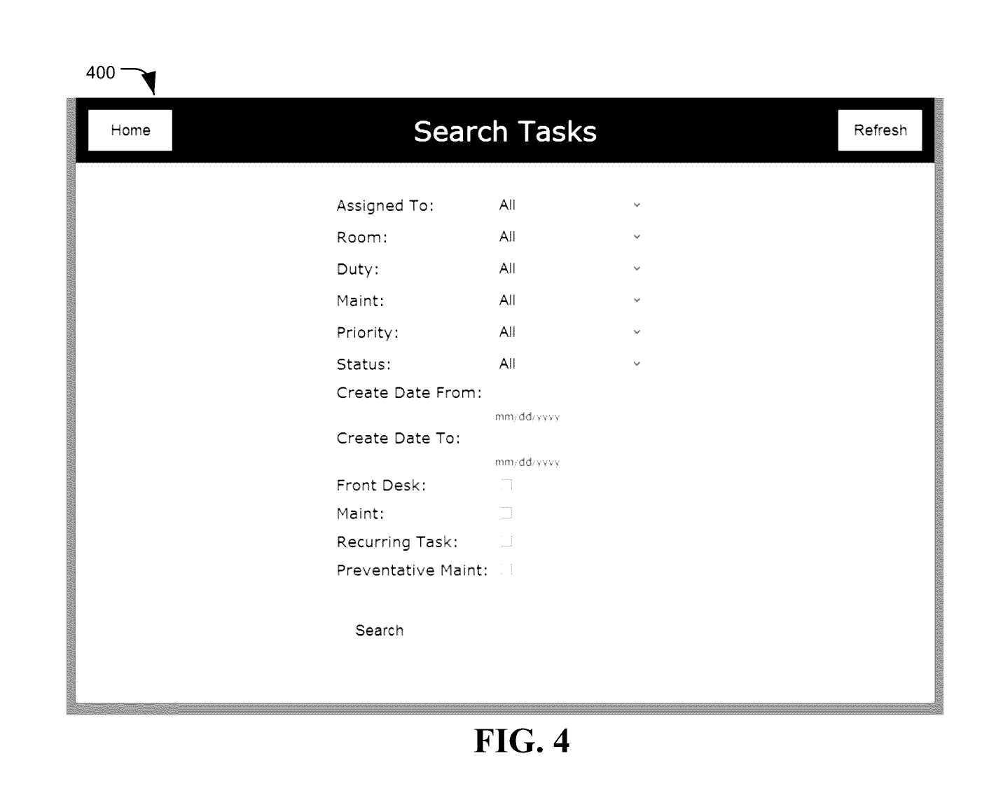

The system 100 may also include various computing devices 102 that are configured for users to access the server 108. The users may include cleaning staff or supervisors 104, maintenance personnel 105, front desk workers 110, supervisors or managers 112, or any combination thereof Each of the computing devices 102 may include a communication interface, processor, and memory to store software instructions (which may be organized into a computer program) that are executable by one or more processors to allow for the functions and features described herein to work. The user devices 102 may include personal computers, tablets, smart phones, cameras, cable boxes, televisions, or other devices with network connectivity. In some embodiments, end users access the system 100 via a web browser accessing a website running on the server 108 (or via another server in communication with server 108) through the network(s) 103. Services and functions of the system 100 may be displayed within the end users' web browsers with no special software running on an end user machine. However, in some embodiments, the user devices 102 may have a graphical user interface (GUI) that is customized based on their assigned tasks, the user device 102, or the system 100. Examples of GUIs capable of operating the systems described herein are provided in FIGS. 4-11. The GUIs may be executed by the user devices.

Further, the system 100 may include a time clock machine 113 that allows employees to clock-in at the beginning of a work shift and clock-out at the end of the work shift, thereby replacing a traditional time-clocking equipment. The system 100 can interface with traditional time-clock equipment to track time worked and compile reports such as comparing the amount of time work versus the tasks completed. This information can also be sent from the time clock machine 113 or the CMS 108 to a payroll company to automate employees getting paid.

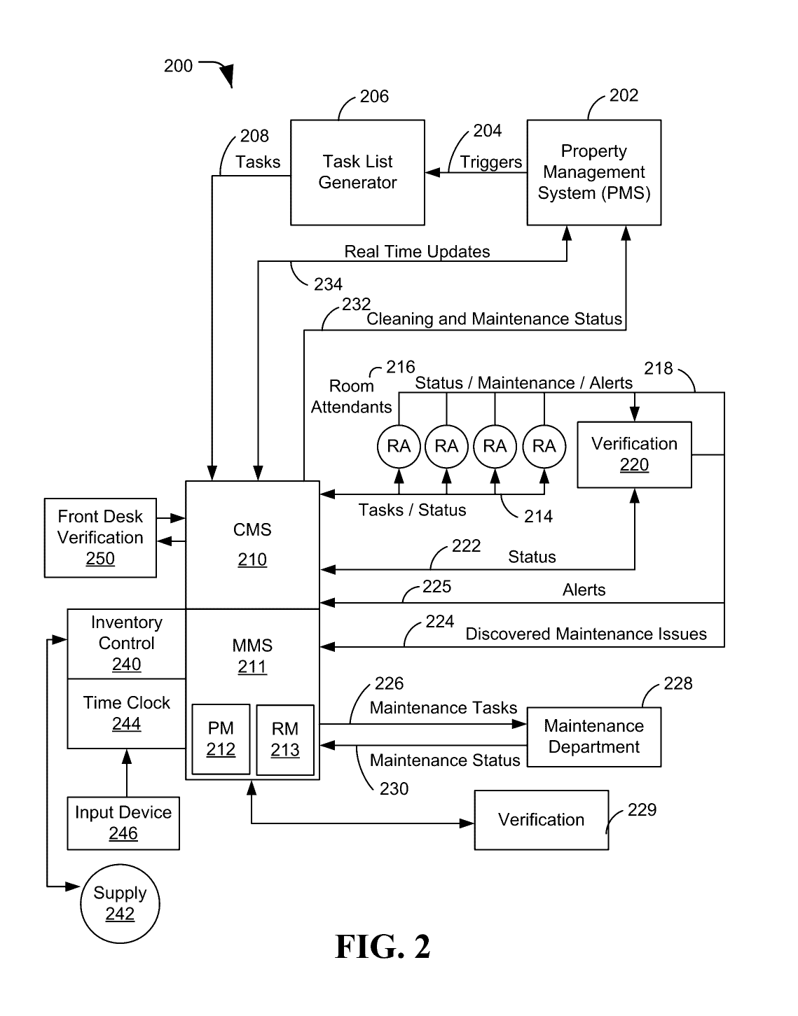

Referring to FIG. 2, a diagram of embodiments of work management systems and methods is shown and generally designated 200. The system 200 may include a CMS 210, MMS 211, or both. As used herein, examples referring to the CMS 210 also optionally include the MMS 211. The CMS 210 and MMS 211 may be in communication with a PMS 202. For example, the CMS 210 or MMS 211 may send data with real-time status updates 234 to the PMS 202. As used herein, the term “real-time” status updates 234 refers to transmission of data through a wired or wireless communication channel to PMS 202 when a change in data occurs at one of user devices 104, 108, 110, and 112 (in FIG. 1).

During operation, the PMS 202 may generate triggers 204 (i.e., data indicating a task must be done) and tasks associated with the triggers 204 may be compiled by a task list generator 206. The task list generator 206 may be separate from the PMS 202 and the CMS 210 or it may be integrated into either. As an example, the PMS 202 may indicate that certain rooms in the hotel have checked out, and upon seeing such trigger, the task list generator 206 may add tasks associated with a checkout to a task list. One or more task lists may be generated by the task list generator 206 and data indicating the tasks 208 may be passed to the CMS 210. The CMS 210 may receive the tasks and add them to a task list at the CMS 210 or MMS 211. The CMS 210 may automatically, without user intervention, assign the tasks to a worker to complete, or the CMS 210 may await a user entry to assign the tasks to worker(s). The task list generator 206 may also include indicator(s) that a task does not need to be done, such as when a guest at the hotel specifically requests no cleaning or indicates a desire not to be disturbed.

In some examples, the CMS 210 may have tasks 214 assigned to room attendants 216 to clean rooms of the hotel. The tasks 214 assigned to each room attendant may be transmitted to a device, such as a smart phone, tablet, or laptop computer. Each room attendant may view their customized task list and perform the tasks. The room attendant's device may communicate a status 218 or other information, such as discovered maintenance issues 224, to the CMS 210 or the MMS 211. In some examples, the room attendant's device may communicate a task completion status to the CMS 210 and the CMS 210 may add a verification task 220 to another worker's task list, such as a head housekeeper, to verify completion of the task to the other worker's satisfaction. Once verification is complete, a verification status 222 of the task may be sent to the CMS 210. The verification status 222 may indicate a task is complete or a task needs to be redone, which can cause a task to be added again to a task list. In particular, the other worker to whom the verification task was assigned may interact with a smart phone or other computing device to indicate the result of the verification, thereby sending a verification status 222 to the CMS 210.

The MMS 211 may manage one or more lists of maintenance tasks, such as a preventative maintenance (PM) list 212 or a reoccurring maintenance (RM) list 213. The maintenance tasks 226 may be sent to a user device for the maintenance department or personnel 228. A status 230 of the maintenance task may be sent back to the MMS 211. In some examples, the RM list 213 may include maintenance tasks that are to be performed every certain number of days, months, or years, such as changing pool filters or changing air conditioning filters. Any type of task that has to be redone on a reoccurring time basis may be added to the RM list 213. The PM list 212 may include tasks that have been reported as issues by a guest or hotel personnel. The PM list 212 may also include tasks that need to be done every so often, such as carpet steam-cleaning, these may be triggered by a number of days, a number of days a room is rented, timing since a last maintenance of the task, other triggers, or any combination thereof Some of the triggers, such as the number of times a room is rented, may be received as indicators or data from the PMS 202. The PM list 212 may indicate tasks for a specific room or a task needed to be done for all rooms. The maintenance tasks, or a status indicator thereof, may also be sent to a manager or other personnel for verification 229.

The MMS 211 may also allow a user to input a maintenance level indicator. For example, the maintenance level indicator may be one of four maintenance priority levels, such as low priority, medium priority, high priority, and a critical priority (which may indicate a hotel room is unrentable). Further, the MMS 211 can track historical tasks to allow personnel to review past maintenance issues.

Also, the user devices may allow for a user to perform various functions in addition to viewing task lists. For example, the room attendants 216, maintenance personnel, and supervisors may have a start button, pause button, and stop button on their devices to indicate when they start and stop a task or to pause the timing of a task if they are interrupted for another reason. In another example, the user devices may be configured to upload a photograph, such as from a camera, tablet, or smartphone, to the CMS 210 or the MMS 211, which can be particularly helpful when identifying maintenance issues.

In an embodiment, each worker may carry a computing device configured to access the CMS 210 or MMS 211 to retrieve tasks, to record notes and/or images, and to update the task list as tasks are completed. By updating the task list, the CMS 210 and the MMS 211 are notified of the change in status. Once a task is complete, the CMS 210 or MMS 211 may send a status indicator 232 to the PMS 202, which may allocate availability of rooms accordingly.

Further, a time clock machine 244 or feature set (software module or GUI) may be integrated into or interface with CMS 210 to provide detailed timing information concerning time worked and time a tasks needed to finish. A time clock feature 244 can be configured to allow employees to clock-in and clock-out on a shift by shift basis, a task by task basis, or a combination of both. The input device 246 may be any electronic device with a clock feature or software module and may be the user devices 102 as shown in FIG. 1. The system 200 will also be able to interface with traditional time clock equipment. The time clock information can be sent to a payroll company to generate a payroll; this may be initiated manually or automatically based on a pay period.

The system 200 may also include an inventory control system 240 that is integrated into or interfaces with the CMS 210 and is configured to allow a manager to set a desired number of inventory at any given time, via a user device such as the user devices 102 shown in FIG. 1. Via the inventory control system 240, which may include a GUI with inventory control features accessible via a server or a remote user device, a supervisor can have the capability of accounting for all the inventory (such as supply 242) on a recurring basis, such as daily, weekly, monthly, or any other basis. The inventory control system 240 can determine when the inventory drops below a certain level (which can be variable and set by a user) and automatic alert lists can be created for ordering purposes. The inventory control system 240 also can include a forecasting module to predict future inventory needs; this may be based on an analysis of historical needs of the inventory over a similar period or situation.

The system 200 may also include a front desk verification features 250 and alert functionality 225 that users such as room attendants and supervisors have access to via the GUI on their respective user device. The alert features enables each user to alert the front desk or system 200 of items needing attention or emergencies, such as smoking in the room, broken items, stolen items, unauthorized pets in the room, and lost & found. Alerts can be generate a task for the front desk to verify or find a resolution for.

In some examples, the PMS 202, the CMS 210, and the MMS 211 may be implemented on the same server or set of servers. Further, the functions of each may be integrated into a single software package. In an alternative example, the PMS 202, the CMS 210, and the MMS 211 may be implemented by modular applications that are separate programs that are configured to interact with one another.

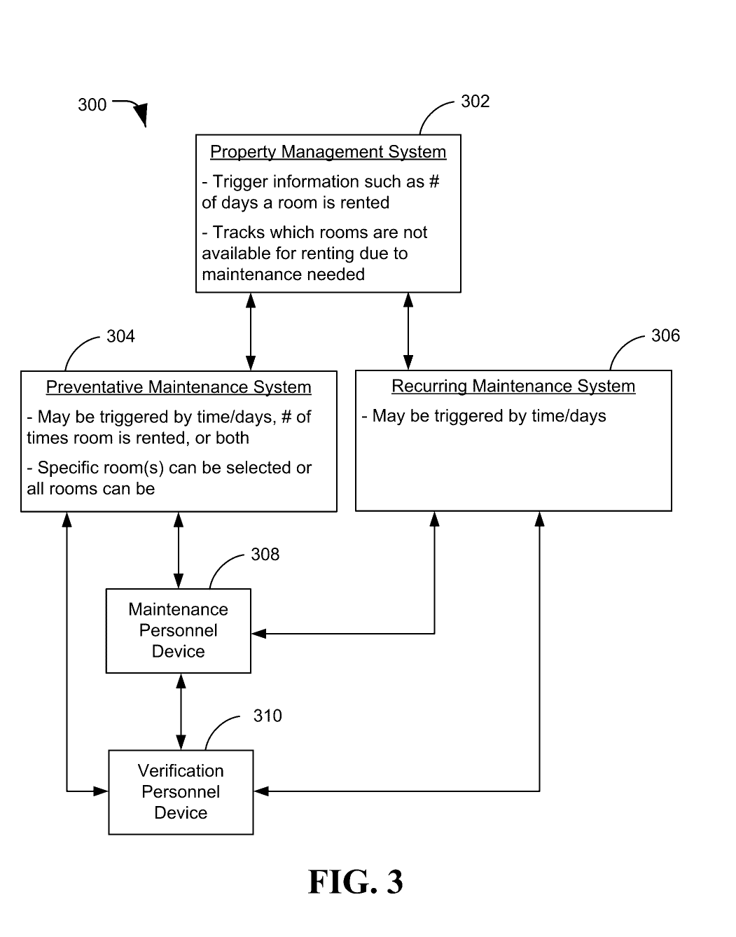

Referring to FIG. 3, a diagram of embodiments of work management systems is shown and generally designated 300. Generally, the system 300 is an example of a maintenance management system. The system 300 may include a preventative maintenance system 304 and a reoccurring maintenance system 306, both or either of which may receive indicators or triggers from a PMS 302 which can add a task list to a corresponding maintenance task list.

The tasks on the maintenance task list(s) may be assigned to a maintenance worker via a computer server (such as MMS server 108 shown in FIG. 1 or MMS 211 shown in FIG. 2) in communication with a user device 308. The user device 308 may have an interface, such as a GUI, to allow the maintenance worker to see the task description, information related to the task, and other information, such as a picture of the problem area that is in need of maintenance. The user device 308 may also be configured to receive user input to allow the maintenance worker to report a status of the task to the server, such as a complete status or pending status. Further, another worker may be assigned a task to verify the maintenance task is done. This can be done by the server assigning a verification task to a second user device 310 for the other worker. In some examples, the user device 308 and the second user device 310 may communicate a status directly (i.e. without need for sending the status to the maintenance system 306, such as using a text message). Once a task is verified, a complete status may be sent to the preventative maintenance system 304, the reoccurring maintenance system 306, or both. The completed task may then be removed from the task list. However, the system 300, via log in a memory (not shown), may track the maintenance tasks.

On an embodiment, the system 300 may be used to track employees as well as task status. In an example, a worker may fail to complete a task and yet indicate completion by interacting with his/her computing device. Another worker may be assigned a verification task, and the result of the verification may be used to determine the quality of an employee's work over time. If, for example, a particular worker fails to perform the assigned tasks, the system may continue to assign a verification task to a supervisor and may automatically elevate the verification task to a higher level employee after a pre-determined number of failures. Further, the system may periodically assign a verification task for other employees. In a particular embodiment, task verification may be performed consistently for new hires and may gradually transition to a periodic verification as the employee gains experience and successfully completes assigned tasks. When periodic verifications reveal that an employee is no longer meeting desired standards with respect to addressing assigned tasks, the system may increases the periodicity of the assigned verification tasks in order to motivate the worker to raise his/her standards.

Referring to FIG. 4, an example of a GUI for a CMS or a MMS is shown and generally designated 400. The GUI 400 may be used by a user such as manager and can include features to allow the user to search the system, such as searching by worker, room, tasks, priority, status, who has opened a task, date, whether a room is occupied, other indicators, or any combination thereof The GUI 400 can provide a robust ability to search tasks by criteria, to search and review historical tasks, and can be available anywhere there is an Internet connection.

In the illustrated example, GUI 400 includes multiple pull-down menus, a clickable calendar to select a date, radio buttons, and a search button. The user may select one or more criteria for a search by clicking on the pull-down menus, the calendar, and the radio buttons and may then select the search button to initiate a search. In an alternative embodiment, GUI 400 may include a text input for receiving a boolean search or for manual entry of data, such as a room number.

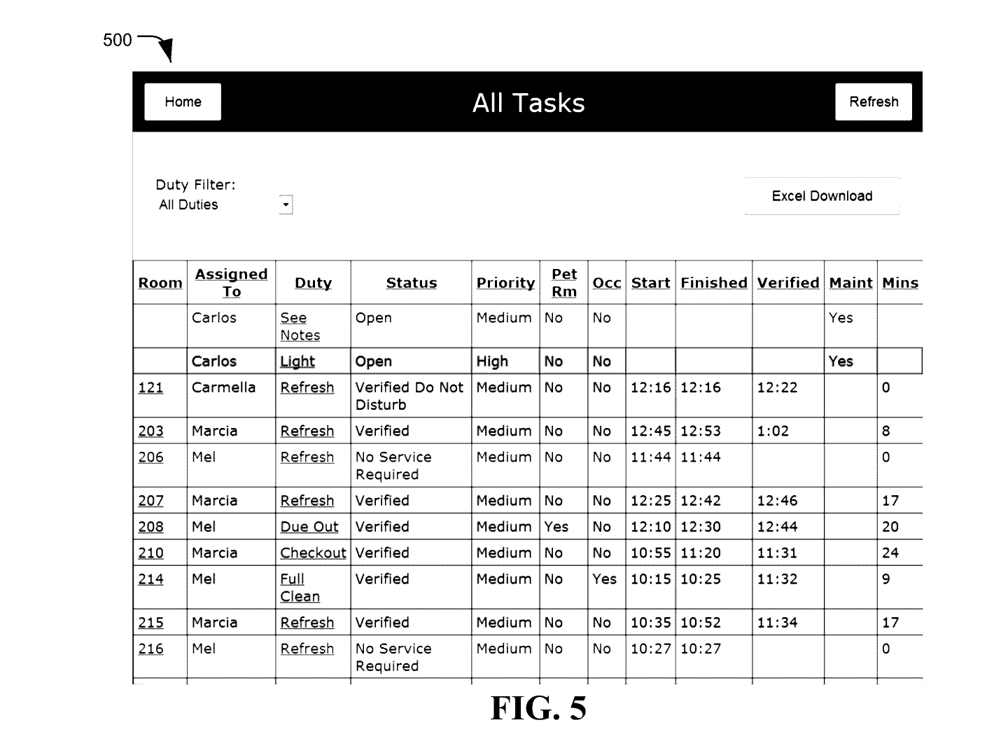

Referring to FIG. 5, an example of a GUI for a CMS or a MMS is shown and generally designated 500. The GUI 500 can be used by a user such as manager to access a task list report for a CMS or MMS, which may be presented to the user in response to his/her interaction with GUI 400 in FIG. 4. For example, a task list report may indicate a task and a corresponding room, a corresponding employee, a supervisor, whether maintenance is needed, a status, a priority, a date created or added to the task list, whether a room has pets, whether a room is occupied, a start time, an end time, a total time to complete a corresponding task, a delete option, other options, or any combination thereof.

In a particular embodiment, the GUI 500 may include notes and other information about the particular room, such as a pre-existing maintenance condition, indications about stains or other developing problems, such as small leaks or a sticking lock, that may soon require remediation. Such notes may provide an early warning system that may be used by administrative personnel to schedule preemptive maintenance.

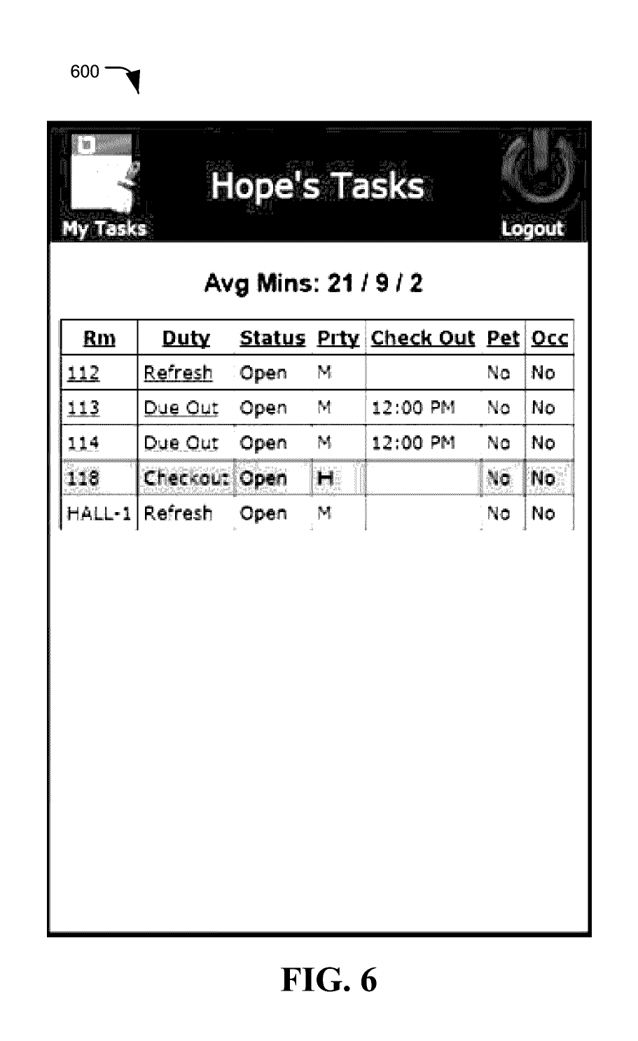

Referring to FIG. 6, an example of a GUI for a CMS or a MMS is shown and generally designated 600. The GUI 600 may be accessible by a user such as a room attendant or other personnel to access a task list assigned to them to complete. The GUI 600 may indicate a subset of the information as compared to the manager report, such as a task, a corresponding room, a status, a priority, whether a room has pets, whether a room is occupied, other options, or any combination thereof. Further, high priority items may be highlighted, such as with a different color background.

In a particular embodiment, GUI 600 may include information about a specific task to be completed. In a hotel context, the room number may be sufficient to indicate the task, since the cleaning tasks may be relatively routine. However, in other contexts, additional information identifying task specific information may be included, further, in some instances, GUI 600 may include a deadline for completion of such tasks.

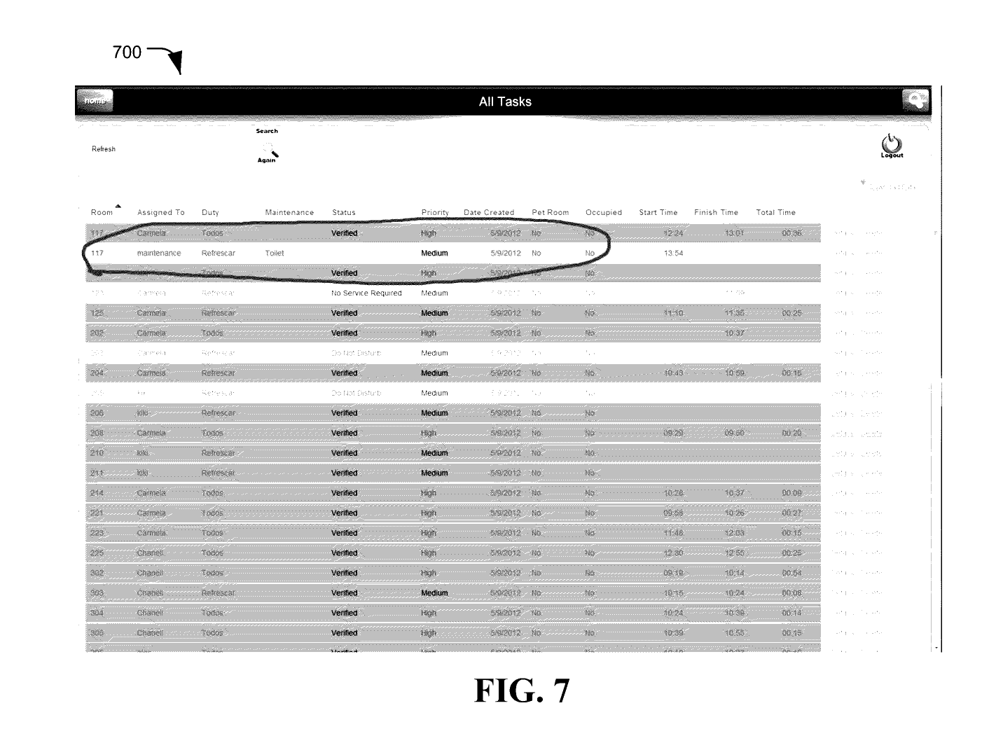

Referring to FIG. 7, an example of a GUI for a CMS or a MMS is shown and generally designated 700. The GUI 700 can be used by a manager to access a task list report for a CMS or MMS. For example, a task list report may indicate an alert that a room or other area needs maintenance. In the report, high priority maintenance items may be highlighted, such as with a different color background, and can be provided to a manager, head housekeeper, a maintenance department, or other personnel. Further, over time, certain tasks may be elevated to high priority maintenance items, such as when an identified task remains uncompleted for a period of time. Such delays may lead administrative personnel to reassign particular tasks and/or to reallocate tasks overall to better distribute the maintenance tasks.

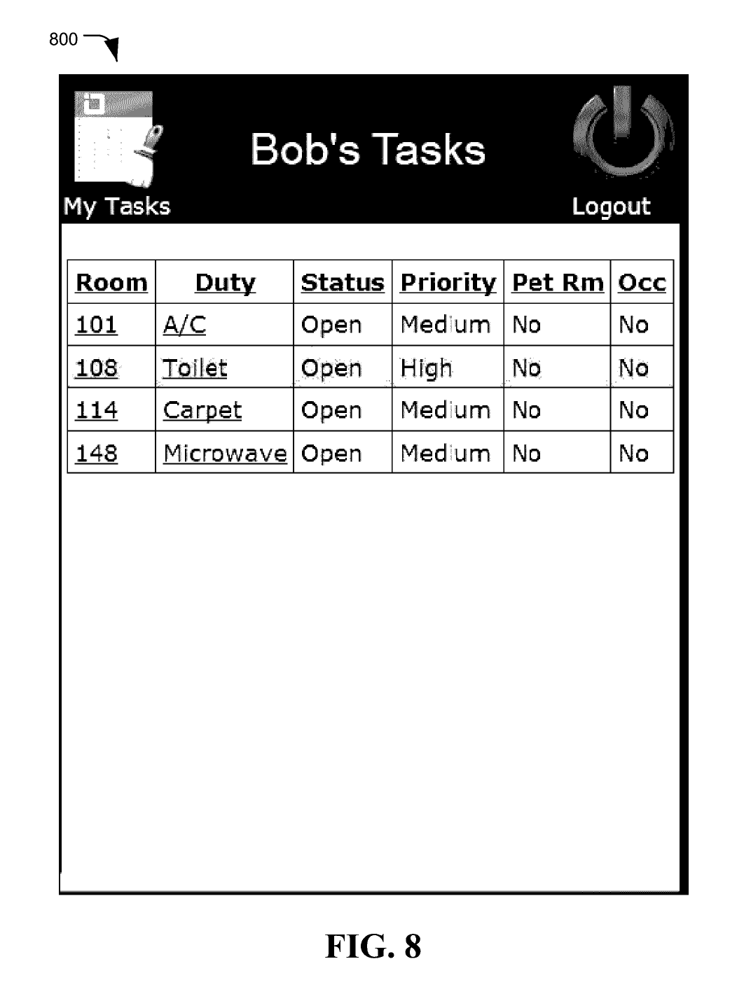

Referring to FIG. 8, an example of a GUI for a CMS or a MMS is shown and generally designated 800. The GUI 800 may be accessible by a user such as a maintenance worker or other personnel to access a task list assigned to them to complete. The GUI 800 may indicate a subset of the information as compared to the manager report, such as a task, a corresponding room or area, a status, and a priority, or any combination thereof Further, high priority items may be highlighted, such as with a different color background. The maintenance staff may be alerted, via the task list of the GUI on a user device, to maintenance issues from the housekeepers or managers. The maintenance tasks may be updated from the MMS to the user device task list(s) as soon as a maintenance issue is determined and input to the MMS. In some examples, hotel guests may also be provided limited access to the MMS to allow the guest to input a maintenance request.

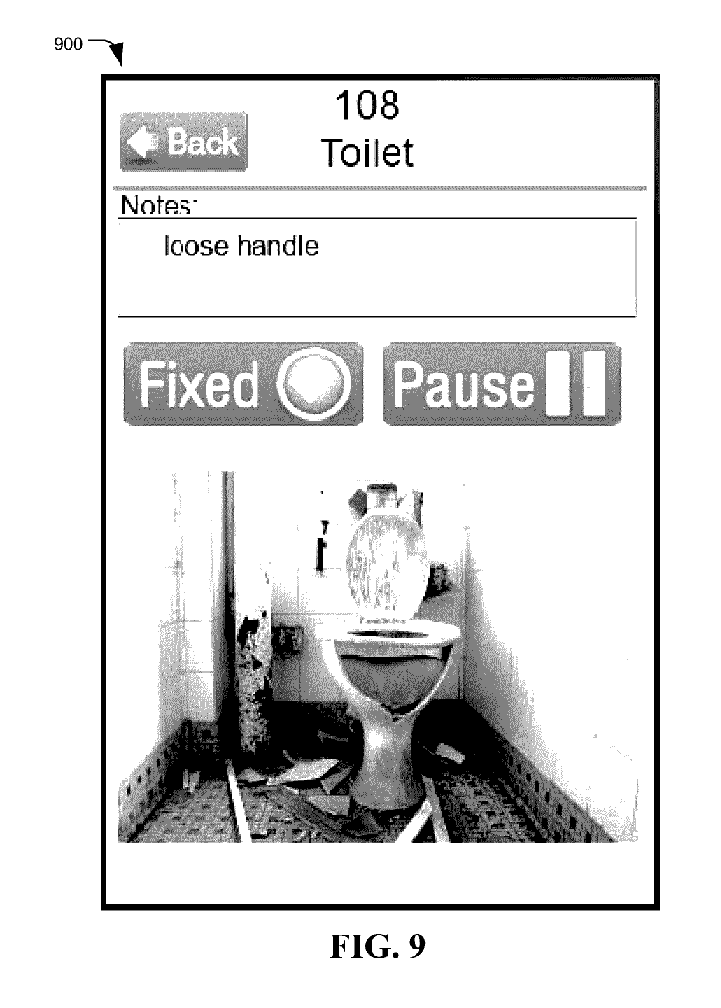

In the illustrated example, the user may click on the “Problem” link listed under the “Status” heading to access further details about the problem. One possible example of a problem with respect to a piece of furniture associated with room 117 is described below with respect to FIG. 9.

Referring to FIG. 9, an example of a GUI for a CMS or a MMS is shown and generally designated 900. The GUI 900 may be accessible by a user such as a maintenance worker or other personnel to access task details. The GUI 900 may indicate a subset of the information as compared to the manager report, such as a task to be done, a corresponding room or area, a status, and a priority, or any combination thereof. Further, a picture of a corresponding maintenance problem may be provided. The picture may have been previously uploaded to the MMS via another user, such as a housekeeper or manager. Further, the maintenance worker may update a status of the task.

In the illustrated example, a picture of a deck chair is shown, which may be on a balcony of a room. In this example, the fabric of the deck chair appears to be ripped away, likely requiring a chair pad or a new chair. Other types of maintenance issues may also be described and/or depicted.

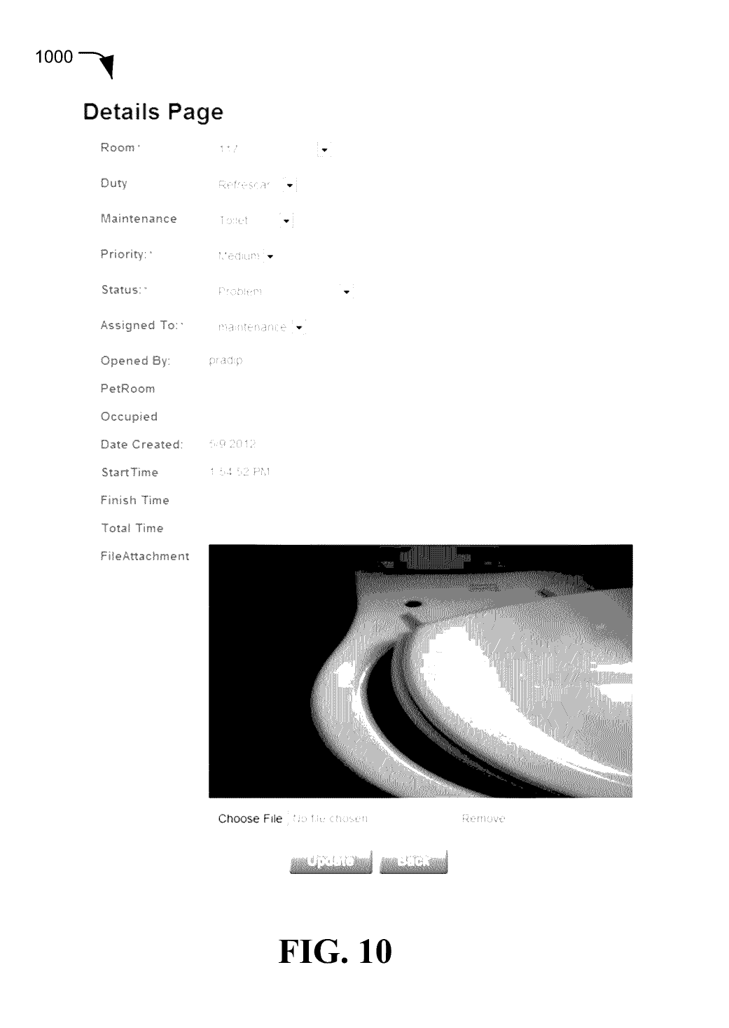

Referring to FIG. 10, an example of a GUI for a CMS or a MMS is shown and generally designated 1000. The GUI 1000 may be accessible by a user such as a head housekeeper or a manager to view detailed information of a maintenance or other task. The GUI 1000 may indicate further information compared to the maintenance task detail shown in GUI 900. Further, a picture of a corresponding maintenance problem may be provided; in addition, an option to upload or change the picture can also be provided. A picture may have been previously uploaded to the MMS via another user, such as a housekeeper or manager. Further, the GUI 1000 can allow the user to change the room number, the task description, the maintenance description, the priority, the status, who the task is assigned to, whether a pet is in a room, whether a room is occupied, and an image representing the task. The GUI 1000 may also show a start time, finish time, and the total time it took to complete the associated task.

In the illustrated example, a broken toilet seat is depicted. In the image of the toilet seat, it appears that one of the bolts that secure the toilet seat has broken or has been removed.

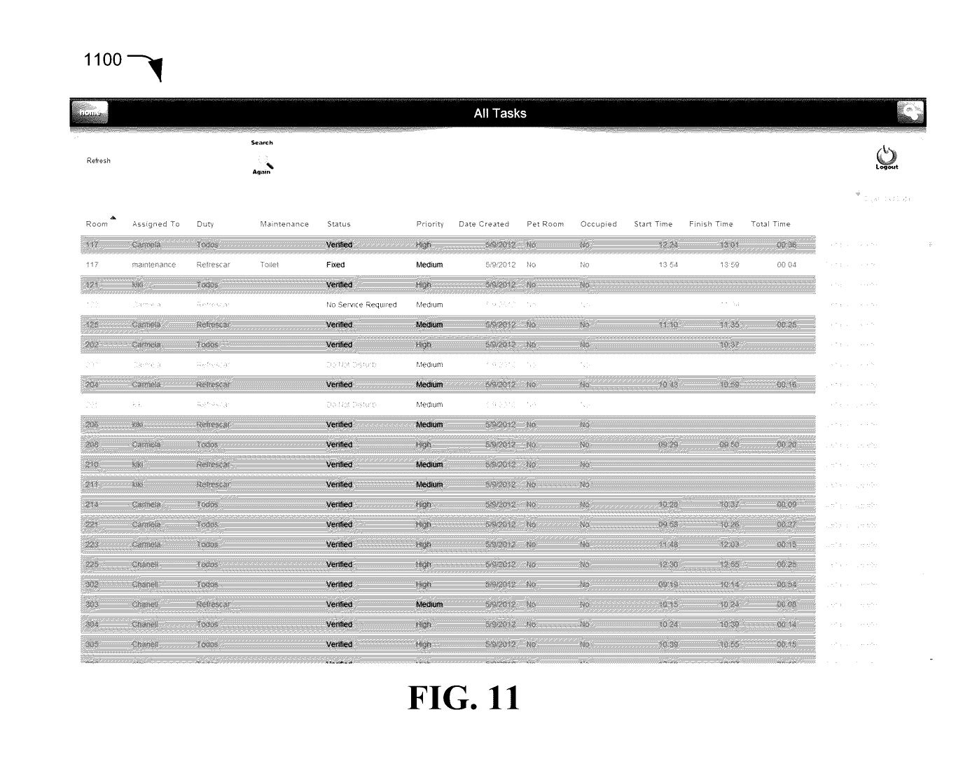

Referring to FIG. 11, an example of a GUI for a CMS or a MMS is shown and generally designated 1100. The GUI 1100 can be used by a manager to access a task list report for a CMS or MMS. For example, a task list report may indicate which tasks have been completed and which tasks have not been completed. In addition, the task list report may indicate a start time, finish time, and the total time it took to complete the associated task, as well as data mentioned above.

In an example, the task list may indicate that some maintenance items have been fixed, some verified, and some indicate “No Service Required” or “Do Not Disturb.” The manager may review the report periodically to see how maintenance is progressing and to take a personal interest if items remain on the list for too long.

The systems and methods described herein can increase employee accountability by time-stamping their activities and maintaining historical records. Further, increases in employee efficiency can be accomplished with instant updates and on-the-fly changes to schedules. Also, the systems described herein can speed up assignment and reassignment of duties. Even further, the systems can track maintenance issues with photographic record(s), eliminate cost and mess of paper systems, and frees a head housekeeper or other worker to work on rooms.

Managers and owners can remotely monitor the daily activities of staff and review historical records. The task lists and records may be stored on a server using an SQL database. The systems can be accessed from anywhere with intern& connect on PC, Mac, or Smartphone. Also, the systems and GUIS can work with popular browsers. Thus, the systems and methods described herein provide an intuitive interface, such as information rich and color coded web interfaces, which can have customizable or different views for managers and housekeepers. The systems also provide instant updates for the users.

Further, a user such as a manager may be able to add tasks to the CMS or MMS, view tasks, view maintenance tasks and triggers, view staff reports, and add staff

The systems may also include and inventory management system, which can have a system to track inventory similar to a CMS. The systems may also provide statistics and analysis, such as allowing a manager to compare data and statistics on tasks to evaluate workers efficiency and production. The systems could also be used fas a restaurant management system. For example, for hotels with restaurants, the systems could track orders, inventory, and staff.

In accordance with various embodiments, the methods described herein may be implemented as one or more software programs running on a computer processor or controller. In accordance with another embodiment, the methods described herein may be implemented as one or more software programs running on a computing device, such as a personal computer. Dedicated hardware implementations including, but not limited to, application specific integrated circuits, programmable logic arrays, and other hardware devices can likewise be constructed to implement the methods described herein. Further, the methods described herein may be implemented as a computer readable storage medium or device including instructions that when executed cause a processor to perform the methods.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a work management system including:
a communication interface configured to communicate data to and receive data from one or more user devices, and also configured to communicate data to and from a property management system (PMS) software application;
a processor;
a memory storing software including a cleaning management system (CMS) software application executable by the processor to perform a method to:
communicate data to and from a hotel's PMS software application via the communication interface;
determine one or more cleaning tasks based on data from the hotel's PMS software application;
add determined cleaning tasks to a task list for the hotel;
assign at least a portion of the determined cleaning tasks on the task list to a specific user to generate a customized task list for the specific user;
allow a user device associated with the specific user to access the customized task list;
update a status of one or more items on the customized task list based on data received from the user device; and
provide a real-time status update to the PMS software application via the communication interface, the real-time status update based on a change in status of at least one of the determined cleaning tasks.

2. The apparatus of claim 1 further comprising:
the communication interface configured to receive real-time status updates from the user device for tasks in the task list and the CMS software application is configured to update the customized task list with the real-time status updates.

3. The apparatus of claim 1 further comprising the work management system includes a server having a database to store the task list.

4. The apparatus of claim 1 further comprising the user device is a wireless-networked computing device configured to display a graphical user interface (GUI) indicating the customized task list.

5. The apparatus of claim 4 further comprising the user device includes a camera and the GUI is configured to upload a picture to associate with a task.

6. The apparatus of claim 5 further comprising the picture is associated with a maintenance task.

7. The apparatus of claim 1 further comprising the customized task list includes a subset of tasks that is less than all of tasks in the task list.

8. The apparatus of claim 1 further comprising the software includes a maintenance management system (MMS) software application executable by the processor to perform a method comprising:
adding maintenance tasks to the task list,
provide at least a portion of the maintenance tasks on the task list to a maintenance provider,
allow a maintenance provider to access the at least a portion of the maintenance tasks via a maintenance provider device, and
update a status of at least one of the maintenance tasks based on data received from the maintenance provider device.

9. The apparatus of claim 8 further comprising the MMS is configured to provide a photograph associated with a maintenance task to the maintenance provider device.

10. The apparatus of claim 9 further comprising the maintenance tasks include a preventative maintenance task list and a reoccurring maintenance task list.

11. The apparatus of claim 8 further comprising the CMS software application and the MMS software application are integrated into a single software package.

12. The apparatus of claim 1 further comprising the software includes a task list generator separate from the PMS software application and the CMS software application, the task list generator configured to determine tasks associated with the data from the PMS and provide the determined tasks to the CMS software application.

13. The apparatus of claim 1 further comprising the CMS software application is configured to automatically, without user intervention, assign tasks to the customized task list.

14. The apparatus of claim 1 further comprising the CMS software application is configured to:
receive a task completion status associated with a specific task on the customized task list from the user device;
add a verification task to another user's task list to verify completion of the specific task; and
receive a verification status from a device associated with the another user, the status indicating whether the specific task is complete.

15. The apparatus of claim 14 further comprising the verification status includes an indicator the specific task is to be redone and the CMS software application is configured to add the specific task to the task list.

16. The apparatus of claim 14 further comprising the CMS software application is configured to:
assign the verification task to a supervisor; and
automatically elevate the verification task to a higher level employee than the supervisor after a pre-determined number of failures of the user to perform the task.

17. The apparatus of claim 1 further comprising the software includes a time clock software module configured to provide detailed timing information about an amount of time a task needed to finish based on a user's clock-in and clock-out on a task by task basis as indicated by the user device.

18. A computer readable storage device, including instructions to implement a cleaning management system (CMS) software application that when executed cause a processor to perform a method comprising:
receiving data at the CMS software application from a hotel's property management system (PMS) software application;
determining one or more cleaning tasks from the data received from the hotel's PMS software application;
adding determined cleaning tasks to a task list for the hotel;
assigning at least a portion of the determined cleaning tasks on the task list to a specific user to generate a customized task list for the specific user;
allowing a user device associated with the specific user to access the customized task list;
updating a status of one or more items on the customized task list based on data received from the user device; and
providing a real-time status update to the PMS software application via a communication interface, the real-time status update based on a change in status of at least one of the determined cleaning tasks.

19. The computer readable storage device of claim 18, including instructions executable by the processor to perform the method further comprising:
adding maintenance tasks to the task list;
providing at least a portion of the maintenance tasks on the task list to a maintenance provider;
allowing a maintenance provider to access the at least a portion of the maintenance tasks via a maintenance provider device; and
updating a status of at least one of the maintenance tasks based on data received from the maintenance provider device.

20. The computer readable storage device of claim 18, including instructions executable by the processor to perform the method further comprising:
sending data with real-time status updates from the CMS software application to the PMS software application when a change in data occurs at the user device.
